(19) United States
(12) Patent Application Publication
(10) Pub. No.: US 2002/0051196 A1
(43) Pub. Date: May 2, 2002

(54) Method and system for ordering prints

(76) Inventor: Kazuhiko Kajiwara, Kaisei-machi (JP)

Correspondence Address: BIRCH STEWART KOLASCH & BIRCH, PO BOX 747, FALLS CHURCH, VA, 22040-0747, US

(21) Appl. No.: 09/974,862

(22) Filed: Oct. 12, 2001

(30) Foreign Application Priority Data
Oct. 13, 2000 (JP) 312875/2000

(51) Int. Cl. G06F 15/00

(52) U.S. Cl. 358/1.15

(57) ABSTRACT

Both a user and a DPE store can obtain a benefit of a network photograph service system at the time of placing an order. A film processor for developing a film, a scanner for reading image data from the film, a database for storing the image data, a printer for printing the image data, a printing terminal, and an order terminal connected to the printing terminal via a LAN are installed in the DPE store. The user places an order for an additional print or the like by using the order terminal after receiving prints generated from the film. At this time, a DP number of a DP bag handed to the user together with the prints is used as user information. Based on the user information, the user accesses the printing terminal via the order terminal, in order to place the order.

### BACKGROUND OF THE INVENTION

1. Field of the Invention

The present invention relates to a method and a system for ordering a print of image data. More specifically, the present invention relates to a method and a system for ordering a print of image data at a DPE store or the like.

2. Description of the Related Art

Digital photograph service systems for carrying out various kinds of digital photograph services, such as storing photographs obtained by users in image servers by digitization of the photographs, recording the photographs in CD-Rs, and receiving orders for additional prints have been known. In such a system, a user installs viewer software for reproducing images recorded in a CD-R in his/her personal computer, and generates order information describing the content of an order for an additional print or the like by using an ordering function of the viewer software. The user then brings the CD-R and the order information to a DPE store and the DPE store hands the order information and the CD-R to a laboratory to generate the additional print or the like as requested.

As one form of such a digital photograph service system, a network photograph service system has also been proposed. In a network photograph service system, digital images of users are stored in (registered with) a system of a service provider and print orders or the like are received via a network such as the Internet.

In such a network photograph service system, in order to provide digital photograph services for users, a server computer comprising a scanner, a printer, and a large-capacity disc (hereinafter called an image server) is installed in a wholesale laboratory. Photographs obtained by users are stored in the image server and various kinds of services such as reception of additional-print orders, attachment of photographs to e-mail messages, and downloading of photograph image data are provided for the users by enabling the users to access the image server.

In such a service, a user accesses the image server by using predetermined application software installed in his/her personal computer and places an order for an additional print is or the like. Meanwhile, the laboratory carries out photographic processing such as additional-print generation, picture-postcard generation, album compilation, composite-image generation or trimming processing on image data. The laboratory transfers the image data after the processing or notifies the user of completion of the processing by sending an e-mail message, for example.

In this service, the user can confirm an image to be printed, simply by using the personal computer. Therefore, the user does not need to find a frame of the image to be printed in a film that has been developed. In this manner, the user can efficiently place the order. In a conventional service, the frame of the image to be printed and a quantity thereof need to be confirmed manually after the film is taken out from a DP bag. However, in the network photograph service system, the film is not involved, and order information is digitized. Therefore, a DPE store can save labor in dealing with the order.

Although the network photograph service system is convenient as has been described above, the image data are stored in the image server and the order is placed through an access to the image server via the network. Therefore, the user cannot place the order at a store he/she has been regularly using. Meanwhile, a DPE store loses customers thereof due to such a network photograph service system, and the profits of the store decreases as a result. In this case, the DPE store itself may install a network photograph service system. However, large-scale equipment is necessary therefor, which is costly for a small-sized DPE store. Furthermore, if a user does not have a personal computer, the user cannot use the network photograph service system and has to order a print from a film as has conventionally been carried out.

### SUMMARY OF THE INVENTION

The present invention has been conceived based on consideration of the above circumstances. An object of the present invention is therefore to provide a print ordering method and a print ordering system enabling both a user and a DPE store or the like to have the same benefits as in a network photograph service system.

A print ordering method of the present invention is used for a print ordering system comprising a printing terminal installed in a DPE store having reading means for obtaining image data by reading images recorded in a film, a database for storing the image data, and a printer for printing the image data. The printing terminal prints the image data stored in the database by reading the image data from the database in response to a print order. The order printing system also comprises

an order terminal installed in the DPE store and connected to the printing terminal by a local network. The print ordering method of the present invention comprises the steps of:

obtaining image data by reading images from a film brought by a user at the time of requesting development and printing of the film;

storing in the database the image data in relation to user information specific to the user and usable only at the store;

inputting the user information, accessing the printing terminal with the user information, receiving an order for a print of the image data related to the user information, and outputting an order number corresponding to the order, by using the order terminal; and

reading the image data from the database based on the order number and printing the image data, by using the printing terminal.

The “film” from which the images are read is a film that has been developed. In the case where a film that has not been developed is handed to the DPE store, the film is developed at the store and used as the film to be read in this method.

At the time of requesting the development and the printing, the film that has not been developed is put in a DP bag, and a receipt slip attached to the bag is provided to the user. After the printing, prints and the film that has been developed are put in the DP bag and handed to the user in exchange for the receipt slip. At this time, a DP number such as a bar code is attached to the DP bag, and the user can be related to the prints by the DP number. Therefore, the DP number attached to the DP bag can be used as the user information. The DPE store may provide the user with a user card dedicated to the store. In this case, a user ID recorded in the user card can be used as the user information. The user ID may be printed on the user card or recorded as magnetic information in the card. The user information includes not only the information described above but also a pass word necessary for accessing the printing terminal by using the order terminal at the time of ordering the print.

The “local network” is a network not connected to the Internet and closed within the store. The printing terminal is accessible only from the order terminal.

The “print order” includes photographic processing such as additional-print generation, picture-postcard generation, album compilation, composite-image generation, and trimming processing, for example. The user can request the processing by using the order terminal.

The “order number” is described on a receipt slip issued by the order terminal at the time the user orders the print by using the order terminal. By handing the receipt slip to a clerk in the store, the order number can be recognized. The DPE store can select the image data and the content of the photographic processing and can print the image data by using the printing terminal, based on the order number described on the receipt slip.

A print ordering system of the present invention comprises a printing terminal installed in a DPE store having reading means for obtaining image data by reading images recorded in a film brought by a user at the time of requesting development and printing of the film, a database for storing the image data in relation to user information specific to the user and usable only in the store, and a printer for printing the image data. The printing terminal prints the image data stored in the database by reading the image data from the database in response to a print order. The print ordering system also comprises

an order terminal installed in the DPE store and connected to the printing terminal by a local network. The print ordering system is characterized by that

the order terminal receives an input of the user information, accesses the printing terminal by using the user information, receives the print order regarding the image data related to the user information, and outputs an order number corresponding to the print order; and

the printing terminal prints the image data by reading the image data from the database based on the order number.

According to the present invention, when the user requests the development and the printing of the film from the DPE store, the film is developed and read, and the printing is carried out based on the image data obtained by the reading. Meanwhile, the image data are stored in the database in relation to the user information. The user receives the prints and the film that has been developed from the store. At the time of placing the order, the user accesses the printing terminal by inputting the user information from the order terminal, and orders the print of the image data related to the user information by using the order terminal. The order number corresponding to the order is output from the order terminal. The user notifies the clerk of the order number, and the clerk deals with the order related to the order number by using the printing terminal. The print obtained in the above manner is then handed to the user.

As has been described above, the print can be ordered without involving the film that has been developed, as in the case of a conventional network photograph service system. Therefore, the user can efficiently place the order, and the DPE store can save labor in dealing with the order. Furthermore, since the order is placed from the order terminal installed in the DPE store, the user can order the print at the DPE store he/she regularly uses. Moreover, since the user information is used only in the store that has carried out the development and the printing of the film, the order is placed only from the order terminal in the store. Therefore, the DPE store can induce the user to use the store without competing with other stores, and the store can increase its profits as a result.

### BRIEF DESCRIPTION OF THE DRAWINGS

FIG. 1 is a block diagram showing a configuration of a print ordering system as a first embodiment of the present invention;

FIG. 2 is a diagram showing a procedure carried out in the first embodiment when a user visits a DPE store for the first time;

FIG. 3 is a diagram showing a procedure carried out in the first embodiment when the user visits the store for the second time;

FIG. 4 is a diagram showing a procedure carried out in the first embodiment when the user visits the store for the third time;

FIG. 5 is a diagram showing a procedure carried out in a second embodiment of the present invention when a user visits a DPE store for the first time;

FIG. 6 is a diagram showing a procedure carried out in the second embodiment when the user visits the store for the second time;

FIG. 7 is a diagram showing a procedure carried out in a third embodiment of the present invention when a user visits a DPE store for the first time; and

FIG. 8 is a diagram showing a procedure carried out in the third embodiment when the user visits the store for the second time.

### DESCRIPTION OF THE PREFERRED EMBODIMENTS

Hereinafter, embodiments of the present invention will be explained with reference to the accompanying drawings.

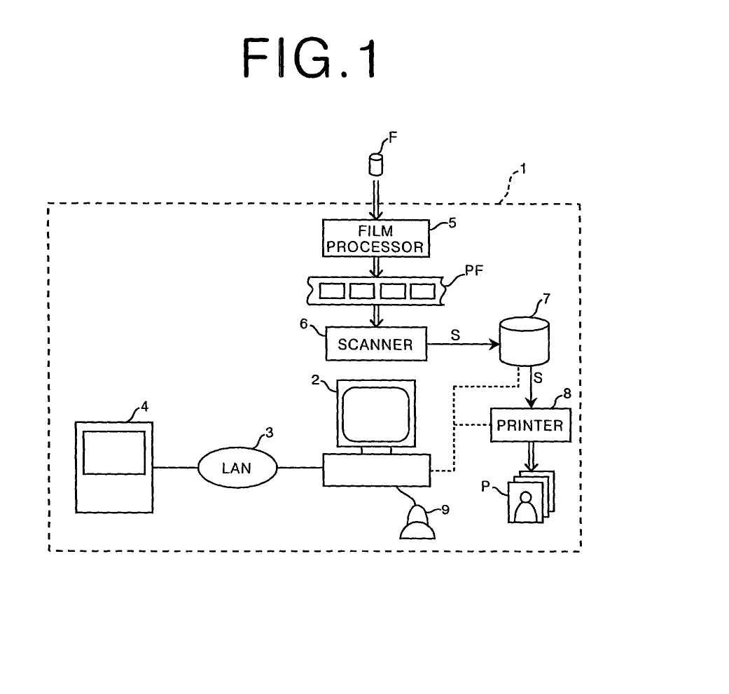

FIG. 1 is a block diagram showing a configuration of a print ordering system as a first embodiment of the present invention. As shown in FIG. 1, the print ordering system in the first embodiment comprises a printing terminal 2 installed in a DPE store 1, an order terminal 4 connected to the printing terminal 2 via a local area network (LAN), 3, a film processor 5 for obtaining a film PF by developing a film F brought by a user to the DPE store 1 at the time of ordering development and printing thereof, a scanner 6 for obtaining image data S by reading images from the film PF, a database 7 for storing the image data S, and a printer 8 for obtaining prints P by outputting the image data S. A film developing/reading apparatus having the functions of the film processor 5 and the scanner 6 may also be used.

The printing terminal 2 carries out printing by using the printer 8 after reading the image data S from the database 7 according to a print order, as will be explained later. The printing terminal 2 has a bar code reader 9 connected thereto in order to read a bar code as will be explained later.

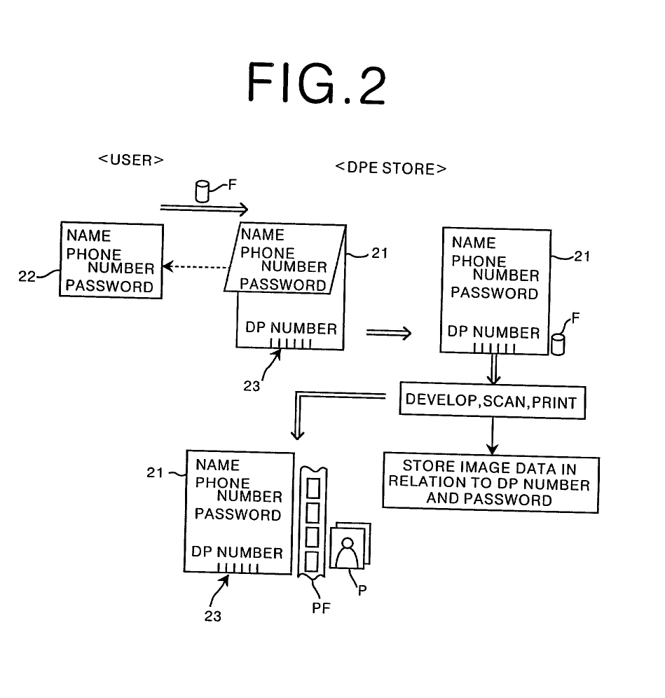

Operation of the first embodiment will be explained next. FIG. 2 shows a procedure carried out in the first embodiment, and this procedure is carried out when the user visits the DPE store for the first time. First, the user brings the exposed film F to the DPE store 1. The DPE store 1 writes down a name, a phone number, and a password necessary for placing an order on a DP bag 21. The password is determined by the user. A DP number usable only in the DPE store 1 is printed as a bar code 23 on the DP bag 21. After writing down the name and the like on the DP bag 21, the DPE store hands a receipt slip 22 to the user. The DPE store 1 develops the film F, and scans the film PF. The prints P are then obtained by printing the image data S. At the time of scanning, the bar code reader 9 reads the bar code 23 printed on the DP bag 21. The image data S are related to the DP number represented by the bar code 23 and temporarily stored in the printing terminal 2. The DP number may be input directly to the printing terminal 2. The image data S related to the DP number are selected from image data temporarily stored in the printing terminal 2, and stored in the database 7 in relation to the DP number and the password.

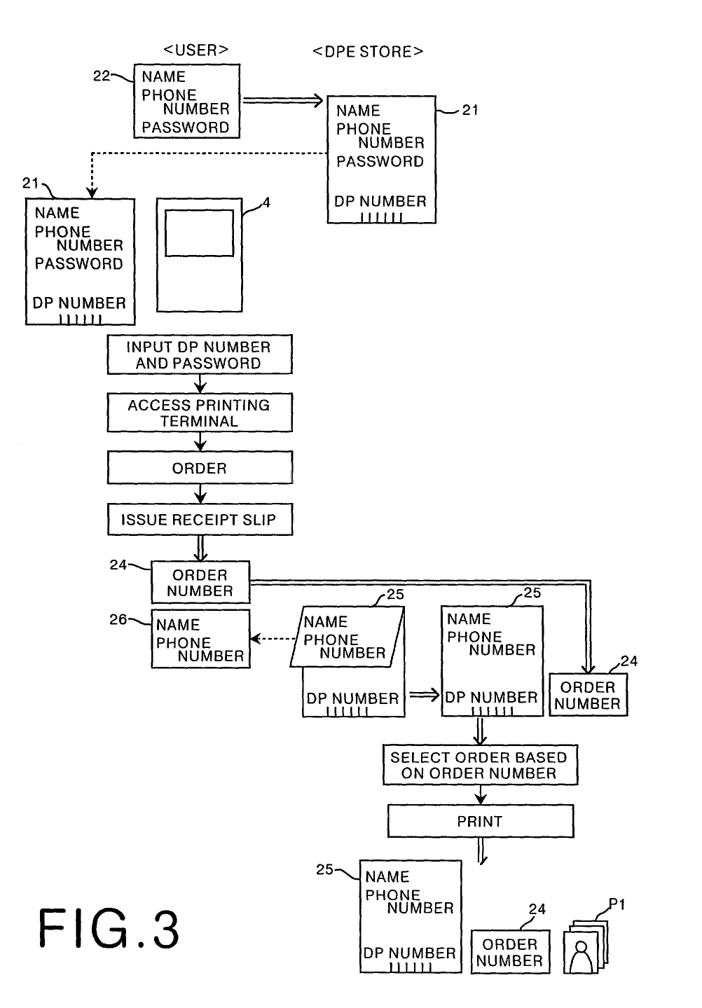

FIG. 3 shows a procedure carried out when the user visits the DPE store for the second time. The user hands the receipt slip 22 to the DPE store 1, and receives the DP bag 21 containing the prints P and the film PF that has been developed, in exchange for payment of a charge. While viewing the prints P, the user 1 selects one or more of the images to be subjected to image processing such as generation of an additional print or a postcard, and places an order by using the order terminal 4. The DP number printed on the DP bag 21 and the password are input from the order terminal 4 to the printing terminal 2, for an access to the printing terminal 2. An order screen for placing the order is then displayed on the order terminal 4. Thumbnail images of the image data S corresponding to the DP number are displayed on the order screen. The user selects the image or images to be subjected to the processing (hereinafter called the selected image) by using the order terminal 4, and further selects the content of the processing. After the user places the order, order information representing the content of the order is generated and transferred to the printing terminal 2. At the same time, the order terminal 4 issues a receipt slip 24 on which an order number corresponding to the order is printed.

The user hands the receipt slip 24 to the DPE store 1. The DPE store 1 writes down the name and the phone number of the user on a new DP bag 25, and hands a receipt slip 26 to the user. The DPE store 1 selects the order by using the printing terminal 2 based on the order number printed on the receipt slip 24. The DPE store then selects the image data S corresponding to the selected images from the plurality of images stored in the print terminal 2 based on the order number and selects the image processing, based on the order. The DPE store obtains a print P1 or prints P1 (hereinafter called prints P1) by printing the image data S corresponding to the selected images.

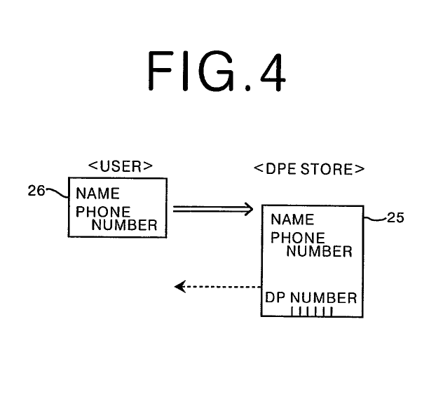

FIG. 4 shows a procedure carries out when the user visits the store for the third time. The user hands the receipt slip 26 to the DPE store 1, and receives the DP bag 25 containing the prints P1 in exchange for payment of a charge.

As has been described above, according to this embodiment, the print order can be placed without involving the film PF that has been developed, as in a conventional network photograph service system. Therefore, the user can place the order efficiently and the DPE store can save labor at the time of dealing with the order. Furthermore, since the order is placed from the order terminal 4 installed in the store 1, the user can place the order from the DPE store he/she regularly uses. Moreover, since the DP number is usable only in the DPE store 1 which has developed the film F, the prints P1 are ordered only from the order terminal 4 installed in the store 1. Therefore, the DPE store 1 can induce the user without competing with other stores, which increases the profits of the store.

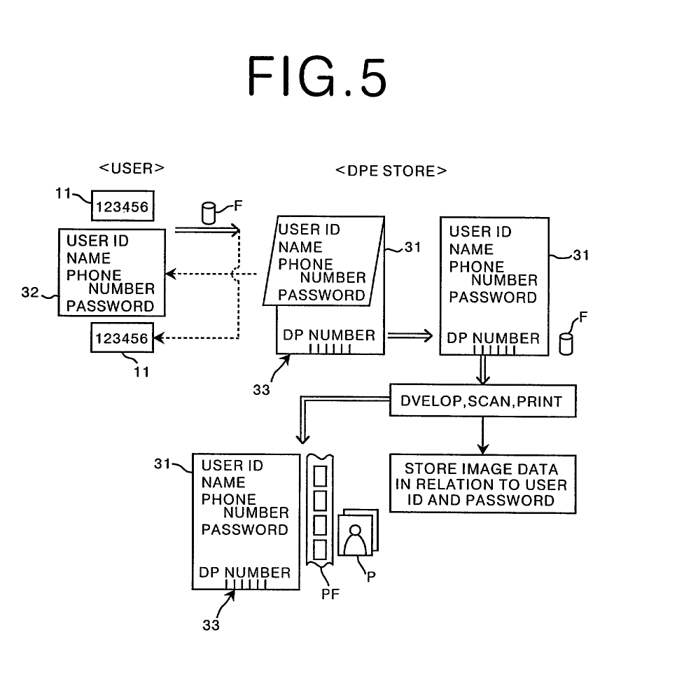

In the first embodiment, the DP number printed on the DP bag 21 is used as the user information at the time of ordering the prints P1. However, a user ID provided in advance for the user by the DPE store 1 may be used as the user information. Hereinafter, the case using a user ID as the user information will be explained as a second embodiment of the present invention. FIG. 5 shows a procedure carried out in the second embodiment when a user visits a DPE store 1 for the first time. A user ID has been provided for the user by being printed on a user card 11 dedicated to the DPE store 1. In this case, the user card 11 may be a magnetic card. Consequently, the user ID may be magnetically recorded therein.

First, the user brings an exposed film F and the user card 11 to the DPE store 1. The DPE store 1 writes down the user ID printed on the user card 11, a name and a phone number of the user, and a password necessary for placing an order on a DP bag 31. The password is determined by the user. A bar code 33 is printed on the DP bag 31 as a DP number usable only in the store 1. The store hands a receipt slip 32 and the user card 11 to the user after writing down the user ID and the like on the bag 31. The DPE store 1 then carries out film development and film scan, and generates prints P by printing. At the time of scanning, a bar code reader 9 reads the bar code 33 printed on the DP bag 31. Image data S are related to the DP number represented by the bar code 33 and temporarily stored in a printing terminal 2. The DP number may be input directly to the printing terminal 2. Meanwhile, the user ID is also input to the printing terminal 2. The image data S related to the DP number are selected from image data temporarily stored in the printing terminal 2 and the selected image data S are stored in a database 7 in relation to the user ID and the password.

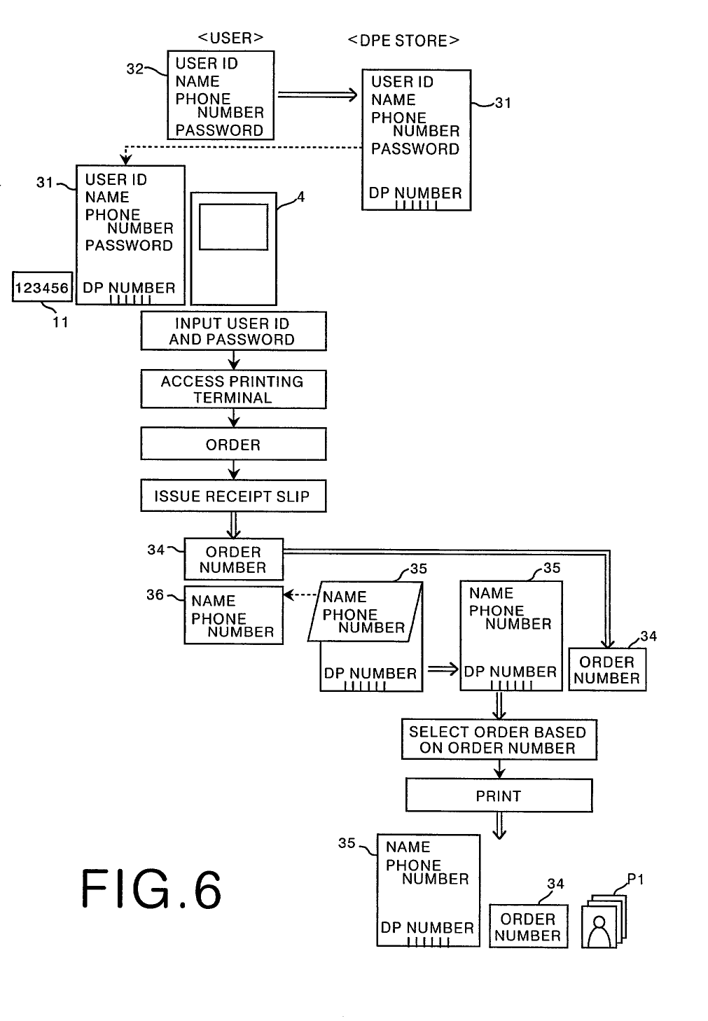

FIG. 6 shows a procedure carried out when the user visits the DPE store 1 for the second time in the second embodiment. The user hands the receipt slip 32 to the DPE store 1 and receives the DP bag 31 containing the prints P and a film PF that has been developed, in exchange for payment of a charge. As in the first embodiment, the user then places an order by using an order terminal 4. At this time, the user ID and the password are input from the order terminal 4 to the printing terminal 2, for an access to the printing terminal 2. The order is then placed in the same manner as in the first embodiment, and the order terminal 4 issues a receipt slip 34 on which an order number corresponding to the order is printed.

The user hands the receipt slip 34 to the DPE store 1. The DPE store 1 writes down the name and the phone number of the user on a new DP bag 35 and hands a receipt slip 36 to the user. The DPE store 1 selects the order by using the printing terminal 2 based on the order number printed on the receipt slip 34, and carries out printing to obtain prints P1 as in the first embodiment. The user receives the prints P1 in exchange for the receipt slip 36 and payment of a charge at the time he/she visits the DPE store 1 for the third time.

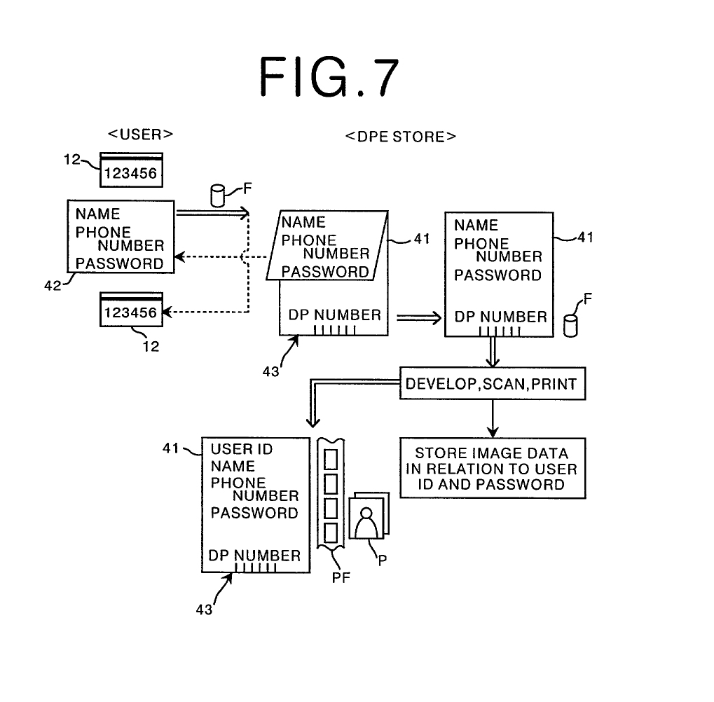

In the second embodiment, the user ID printed on the user card 11 is written down on the DP bag 31 and input to the printing terminal 2 in order to relate the user ID to the image data S. However, in the case where the user information is magnetic information, a card reader (not shown) may be connected to the printing terminal 2 so that the card reader can read the user ID from the user card. Hereinafter, the case where a user ID is read from a user card will be explained as a third embodiment of the present invention. FIG. 7 shows a procedure carried out in the third embodiment when a user visits a DPE store 1 for the first time.

The user brings an exposed film F and a user card 12 to a DPE store 1. The DPE store 1 writes down on a DP bag 41 a name, a phone number of the user and a password necessary for placing an order. The password is determined by the user. At this time, a card reader connected to a printing terminal 2 reads a user ID recorded in the user card 12. A DP number usable only in the store is printed as a bar code 43 on the DP bag 41. The DPE store 1 hands a receipt slip 42 and the user card 12 to the user after writing down the name and the like on the DP bag 41. The DPE store 1 then carries out film development and film scan, and generates prints P by printing. At the time of scanning, a bar code reader 9 reads the bar code 43 printed on the bag 41. Image data S are related to the DP number represented by the bar code 43, and temporarily stored in the printing terminal 2. The DP number may be input directly to the printing terminal 2. The image data S related to the DP number are selected from image data temporarily stored in the printing terminal 2 and the image data S are stored in a database 7 in relation to the password and the user ID that has been read.

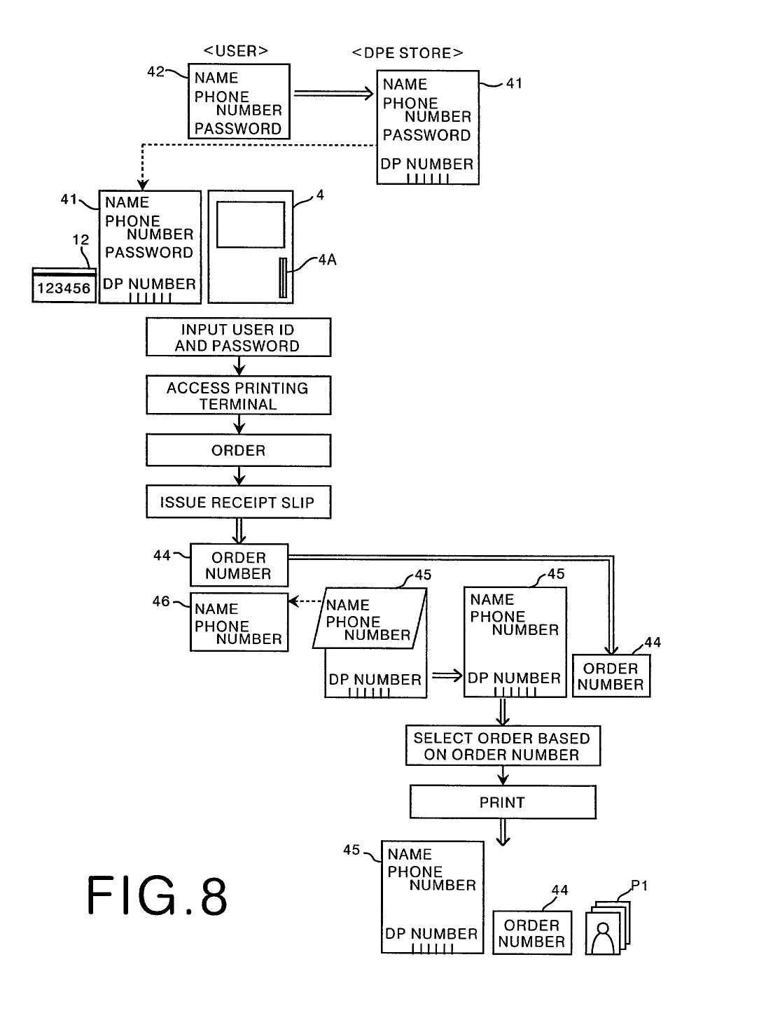

FIG. 8 shows a procedure carried out in the third embodiment when the user visits the DPE store 1 for the second time. The user hands the receipt slip 42 to the DPE store 1, and receives the DP bag 41 containing a film PF that has been developed and the prints P, in exchange for payment of a charge. The user then places an order as in the first embodiment, by using an order terminal 4. In the third embodiment, the order terminal 4 comprises a card reader 4A. The user ID is read from the user card 12 and input together with the password from the order terminal 4 to the printing terminal 2 for an access to the printing terminal 2. The order is then placed as in the first embodiment, and the order terminal 4 issues a receipt slip 44 on which an order number corresponding to the order is printed.

The user hands the receipt slip 44 to the DPE store 1. The DPE store 1 writes down the name and the phone number of the user on a new DP bag 45, and hands a receipt slip 46 to the user. The DPE store selects the order by using the printing terminal 2 based on the order number printed on the receipt slip 44, and carries out printing as in the first embodiment to obtain prints P1. Thereafter, the user receives the prints P1 in exchange for the receipt slip 46 and payment of a charge at the time he/she visits the store for the third time.

In the embodiments described above, only one order terminal 4 is installed in the DPE store 1. However, a plurality of the order terminals may be installed in the DPE store 1.

What is claimed is:

1. A print ordering method used for a print ordering system comprising:
a printing terminal installed in a store having reading means for obtaining image data by reading images recorded in a film, a database for storing the image data, and a printer for printing the image data, the printing terminal printing the image data stored in the database by reading the image data from the database in response to a print order; and
an order terminal installed in the store and connected to the printing terminal by a local network, the print ordering method comprising the steps of:
obtaining image data by reading images from a film brought by a user at the time of requesting development and printing of the film;
storing in the database the image data in relation to user information specific to the user and usable only at the store;
inputting the user information, accessing the printing terminal with the user information, receiving an order for a print of the image data related to the user information, and outputting an order number corresponding to the order, by using the order terminal; and
reading the image data from the database based on the order number and printing the image data, by using the printing terminal.

2. A print ordering method as defined in claim 1, wherein the user information is a DP number printed on a DP bag used at the time of requesting the development and the printing of the film.

3. A print ordering method as defined in claim 1, wherein the user information is a user ID recorded in a user card provided for the user in advance.

4. A print ordering system comprising:
a printing terminal installed in a store having reading means for obtaining image data by reading images from a film brought by a user at the time of requesting development and printing of the film, a database for storing the image data in relation to user information specific to the user and usable only in the store, and a printer for printing the image data, the printing terminal printing the image data stored in the database by reading the image data from the database in response to a print order; and
an order terminal installed in the store and connected to the printing terminal by a local network,
the order terminal receiving an input of the user information, accessing the printing terminal by using the user information, receiving the print order regarding the image data related to the user information, and outputting an order number corresponding to the print order, and
the printing terminal printing the image data by reading the image data from the database based on the order number.

5. A print ordering system as defined in claim 4, wherein the user information is a DP number printed on a DP bag used at the time of requesting the development and the printing of the film.

6. A print ordering system as defined in claim 4, wherein the user information is a user ID recorded in a user card provided for the user in advance.
